(19) United States
(12) Patent Application Publication
(10) Pub. No.: US 2004/0079517 A1
(43) Pub. Date: Apr. 29, 2004

(54) Body cooling apparatus

(75) Inventors: Doug Bueley, Petawawa (CA); Pierre Voisine, Casselman (CA); John Charles Tutton, North Gower (CA); Robert David Watters, Ottawa (CA)

Correspondence Address: WOOD, PHILLIPS, KATZ, CLARK & MORTIMER, 500 W. MADISON STREET, SUITE 3800, CHICAGO, IL, 60661, US

(73) Assignee: Med-Eng Systems Inc.

(21) Appl. No.: 10/282,616

(22) Filed: Oct. 29, 2002

(51) Int. Cl. F28F 7/00; F16F 1/34; F28F 1/00; F24H 3/02; F28F 13/00

(52) U.S. Cl. 165/46; 165/71; 165/120; 165/136; 165/138

(57) ABSTRACT

The present invention is a system for managing heat stress by both controlling the core body temperature of an individual and facilitating hydration. The system provides cooling to an individual through means of a liquid coolant such as water which is circulated by a pump through a heat exchanger to a heat exchange garment. The liquid coolant passes through the heat exchange garment where it extracts heat, increasing in temperature as a result of heat removed from the individual wearing the garment. The liquid coolant is then returned to the heat exchanger where it is again cooled. The cycle is then repeated. A drinking outlet provides a means for hydrating the wearer.

### FIELD OF THE INVENTION

The present invention relates to a heat exchanging apparatus, and in particular to an apparatus for cooling the body of an individual in heat stress.

### BACKGROUND OF THE INVENTION

Certain occupations are known to expose individuals to heat stress resulting from the use of protective clothing and/or exposure to harsh environmental conditions. Examples of these occupations include fire fighting, hazardous materials (HAZMAT) cleanup, brick-firing and ceramics operations, iron and steel foundry operations, laundry and dry cleaning, and explosive ordnance disposal (ROD). As well, athletes training or competing in the outdoors can be vulnerable to heat stress. Heat stress can result in illnesses such as heat cramps, fainting, heat exhaustion, heat stroke, and dehydration. All of these illnesses can have a major effect on both performance and safety.

In order to prevent or decrease the effects of heat stress, a number of body cooling systems have been developed. The three kinds of body cooling systems that are most prominent are ice cooling systems, circulating air systems, and liquid cooling systems.

Ice cooling systems usually consists of ice packets held in pockets in a garment such as a vest. These “ice vest” garments are designed to cool the torso due to the large surface area available for heat exchange. The ice vest garment is worn close to the skin and as such provides cooling to the wearer of the garment by conduction. Ice packets filled with water are generally used, although carbon dioxide (dry ice) can also be used. The cooling offered by the ice packets lasts only a limited number of hours depending on the intensity and frequency of the work performed by the wearer of the ice vest garment. Ice vests are heavy and require doffing to replenish the cooling medium. As well, they do not allow the user to control the rate of cooling. Another concern is that the very high temperature difference between ice (less than 0° C.) and the skin of the wearer of the garment may cause localized ‘freeze’ burns.

An alternate means of body cooling is with circulating air systems. Such systems typically include a torso garment, a compressor, and an umbilical cord which carries pre-chilled air from the compressor to the garment. The pre-chilled air circulates around the body of the wearer under the garment, increasing the evaporation of sweat, and to a lesser extent provides cooling by convection, and then exits through cuffs or special vents. Cooling capacity can be enhanced with the use of compressed air and a vortex tube that reduces the air temperature supplied to the distribution system. An example of a circulating air system is U.S. Pat. No. 5,386,823 to Chen. Circulating air systems, however, are noisy and require a constant source of compressed air supplied through an attached air hose, thus limiting worker mobility. These systems can also lead to more rapid dehydration. While the cool, dry air supplied feels comfortable to the wearer of the garment, the wearer may not realize that hydration through frequent liquid ingestion is still required to minimize the adverse effects of heat stress.

A third body cooling system that is available is known as a liquid cooling system. A liquid cooling system provides cooling of the skin through a steady flow of cool liquid through closed circuits of tubing in a suit. U.S. Pat. No. 4,691,762 to Elkins et al is exemplary of such a system. In such systems a chilled liquid, usually water, is circulated by a pump through a heat exchanger to a user wearable garment. The fluid passes through tubes in the garment where it extracts heat before returning to the heat exchanger where it is again cooled. The cycle is then repeated. Ice is typically used as the heat sink for the heat exchanger. Liquid cooling systems have the advantage of allowing significant wearer mobility and independence.

Adequate fluid replacement can be at least as important as cooling when seeking to minimize the effects of heat stress. It is well understood that proper hydration through fluid ingestion helps maintain health, safety and an optimal physical performance. It is also known that without adequate fluid replacement, dehydration and even hyperthermia can occur. Water loss occurs during the evaporation of sweat from the surface of the skin, which acts to rid the body of excess heat. The effects of water loss are further enhanced by the intensity of the activity, the temperature, relative humidity, clothing, physical fitness and acclimatization of an individual. To prevent the occurrence of dehydration and heat-induced disorders, it is extremely important to maintain the necessary body fluid levels, which involves consuming water prior to, during and following an activity that takes place over a sustained amount of time.

### SUMMARY OF THE INVENTION

In accordance with an aspect of the present invention there is provided a portable personal cooling and hydration system comprising:

a heat exchange garment incorporating a garment inlet, a garment outlet and a garment fluid path extending from the garment inlet to the garment outlet;

a heat exchanger having an exchanger inlet, an exchanger outlet and a heat sink wherein the heat exchanger is adapted to receive a supply of fluid through the exchanger inlet and to emit cooled fluid from the exchanger outlet;

a pump;

a plurality of conduits interconnecting the garment fluid path, the heat exchanger and the pump in a circuit, the circuit being adapted to conduct a fluid in operation; and

a reservoir containing a drinkable fluid, associated with the heat exchanger, and incorporating a drinking outlet;

wherein the heat exchanger, the pump, the plurality of conduits and the reservoir are adapted to be carried by a user of the heat exchange garment.

The present invention is a system for managing heat stress by both controlling the core body temperature of an individual and facilitating hydration. The system provides cooling to an individual through means of a liquid coolant such as water which is circulated by the pump through the heat exchanger to the heat exchange garment. The liquid coolant passes through the heat exchange garment where it extracts heat, increasing in temperature as a result of heat removed from the individual wearing the garment. The liquid coolant is then returned to the heat exchanger where it is again cooled. The cycle is then repeated. The drinking outlet provides a means for hydrating the wearer.

In one embodiment, the system of the present invention is a self-contained portable unit worn by an individual. The portable unit comprises a backpack for housing the heat exchanger, the circulating pump, and the tubing necessary to carry liquid coolant between the heat exchanger and the heat exchange garment. The heat exchanger comprises a sealed, insulated bag containing copper tubing surrounded by a reservoir of liquid such as ice water. The pump circulates liquid coolant out of the heat exchanger and into a heat exchange garment which typically comprises a vest or pants containing a plurality of hollow tubes sewn into the garment. A drinking tube is connected to a drinking port in the bag so that the individual can hydrate himself/herself.

### BRIEF DESCRIPTION OF THE DRAWINGS

In figures which illustrate, by way of example only, embodiments of the present invention,

FIG. 1 is a schematic plan view of a heat exchanger in accordance with the present invention;

FIG. 2 is a schematic plan view of the cooling loop of the present invention;

FIG. 3 is a schematic front view of the inside of a typical heat exchange garment that can be used in association with the present invention;

FIG. 4 is a perspective view an embodiment of the present invention contained in a backpack;

FIG. 5 is a perspective view of the backpack of FIG. 4 shown carried on the back of a wearer; and

FIG. 6 is a perspective view of the wearer of FIG. 5 ingesting fluids from the backpack of FIG. 4.

### DETAILED DESCRIPTION OF THE PREFERRED EMBODIMENT

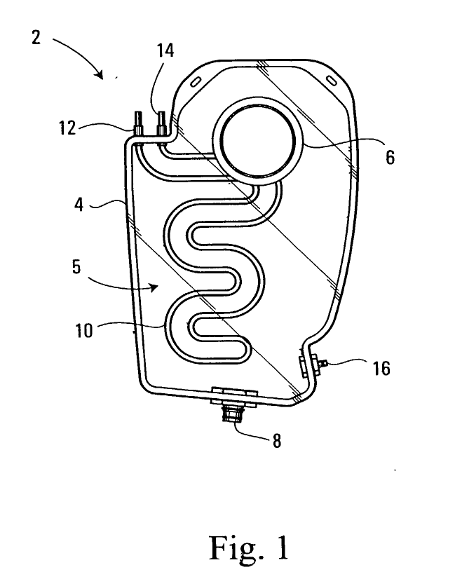

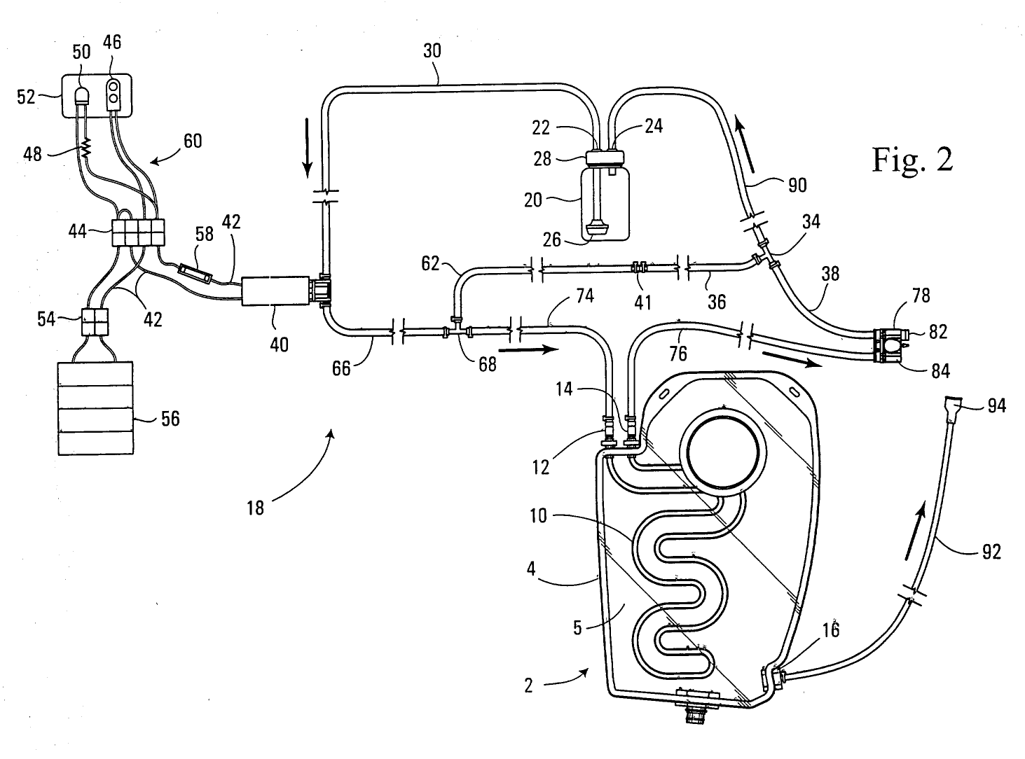

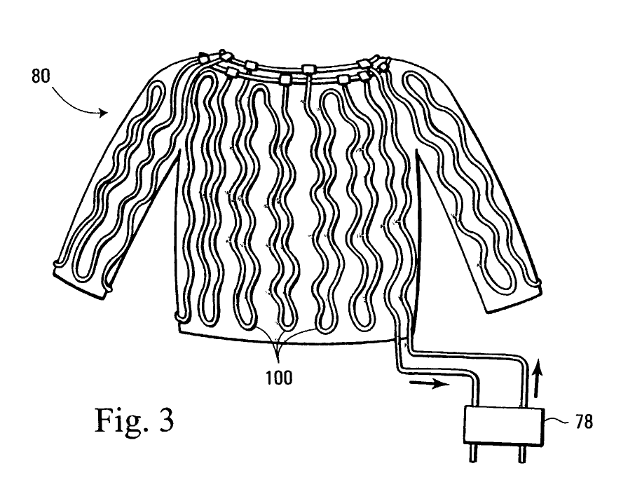

FIG. 1 shows a heat exchanger 2 which is a component of a cooling loop 18 depicted in FIG. 2. In brief, a circulating cooling fluid passes through cooling loop 18 and a heat exchange garment 80 shown in FIG. 3. As this fluid passes through the heat exchange garment it absorbs heat, cooling the individual wearing the garment. After the circulating cooling fluid leaves the heat exchange garment, it is pumped through heat exchanger 2, which transfers the heat from the circulating cooling fluid to a heat sink. The cycle then repeats itself until switched off.

Heat exchanger 2 is defined by a watertight reservoir 4. The reservoir 4 is preferably made of a lightweight flexible material such as treated nylon or a heavy plastic. A screw cap 6 is located at an upper end of the reservoir 4. Screw cap 6 is mated with a hole (not shown) in reservoir 4. When in place, screw cap 6 forms a watertight seal with reservoir 4.

When screw cap 6 is removed, reservoir 4 is filled with a heat sink liquid 5 which is poured through the hole. Heat sink liquid 5 is preferably a mixture of ice and water, made up predominately of ice. Alternatively, other drinkable fluids (preferably in partially frozen state) may also be used.

Reservoir 4 includes a drain valve 8 at its lower end. Drain valve 8, as well as the various other tubes and connectors described herein, is preferably of a type known in the art and formed from PVC (polyvinyl chloride). Drain valve 8 is normally in a closed position. However, drain valve 8 is opened when reservoir 4 is emptied for cleaning or before heat sink liquid 5 is replenished.

A copper tube 10 is positioned as shown within reservoir 4. Although preferably made of copper, the copper tube 10 may be made of any similar highly heat conductive material known in the art. The copper tube 10 is a single continuous tube which describes a circuitous route within the reservoir 4. The copper tube 10 is fixedly positioned within the reservoir 4 by an inlet connector 12 and an outlet connector 14 at opposite ends of the copper tube 10. The connectors 12 and 14 extend through the reservoir 4 and seal an interior of the copper tube 10 from the reservoir 4 and seal the reservoir 4 from leakage. When the reservoir 4 is filled, the copper tube 10 is surrounded by the heat exchange fluid 5.

The reservoir 4 also has a connector 16 at a lower end. The connector 16 extends from the interior to an exterior of the reservoir 4. The operation of the connector 16 will be explained further in reference to FIG. 2.

FIG. 2 shows the heat exchanger 2 in the cooling loop 18. The cooling loop 18 is a hydraulic circuit which contains a circulating cooling fluid. The circulating cooling fluid is preferably water but can alternatively be another heat exchange fluid known in the art such as antifreeze.

The cooling loop 18 is primarily comprised of the heat exchanger 2, a pump 40, a replenishing reservoir 20, a heat exchange garment (shown only in FIG. 3), and a series of interconnecting tube segments. The replenishing reservoir 20 is a small container, of plastic or other lightweight watertight material. The replenishing reservoir 20 is a known requirement of a hydraulic circuit needed to replenish losses of the circulating cooling fluid.

A cap 28 seals the replenishing reservoir 20. An inlet hole 24 and an outlet hole 22 are defined through the cap 28. A first end of a tube segment 30 extends through the outlet hole 22 and a first end of a tube segment 90 extends through the inlet hole 24. The tube segment 30 and the tube segment 90 are sealed to the respective holes 22 and 24. It is understood that all the tubing interconnections described herein form watertight seals. A filter 26 covers the first end of the tube segment 30. The filter 26 is of a type known in the art. The filter 26 allows the circulating cooling fluid to enter the tube segment 30 while blocking dirt or other debris.

A second end of the tube segment 30 is interconnected to a fluid inlet of the pump 40. The pump 40 is a positive displacement pump, preferably a gear pump or diaphragm pump. The pump 40 is powered by a battery pack 56 and controlled by an on/off controller 52. The battery pack 56 preferably consists of 4 D-cell batteries but rechargeable or other battery combinations may be used. The pump 40, the battery pack 56 and the on/off controller 52 are interconnected in an electrical circuit 60 by a series of electrical wires 42. A fuse 58 forms part of an electrical interconnection between the battery pack 56 and the pump 40 to protect the pump 40 from overload.

The on/off controller 52 has an on/off switch 46 and, optionally, an LED (light emitting diode) 50 or other known indicator. The LED 50 is connected to the electrical circuit 60 through a resistor 48. The on/off switch 46 is of a push button type. In operation, the LED 50 is lighted when the pump 40 is turned on. An electrical connector 54 allows the battery pack 56 to be disconnected from the electrical circuit 60 and an electrical connector 44 similarly allows the on/off controller 52 to be disconnect from the electrical circuit 60.

A fluid outlet of the pump 40 is interconnected to a T-junction 68 by a tube segment 66. A first outlet of the T-junction 68 is interconnected to an inlet of a relief valve 41 by a tube segment 62. The relief valve 41 is of a type known in the art. The relief valve 41 is normally in a closed position such that no circulating cooling fluid is flowing through the tube segment 62. A second outlet of the T-junction 68 is interconnected to the inlet connector 12 of the heat exchanger 2 by a tube segment 74. The outlet connector 14 of the heat exchanger 2 is in turn interconnected to a quick disconnect valve 78 by a tube segment 76.

The quick disconnect valve 78 connects to a heat exchange garment 80 (shown is FIG. 3). The quick disconnect valve 78 has an outlet 84 to the heat exchange garment 80 and a return 82 from the heat exchange garment. The return 82 is further connected to a tube segment 38. A second end of the tube segment 38 is coupled to a T-junction 34. A second inlet of the T-junction 34 is connected to a tube segment 36. The tube segment 36 interconnects the T-junction 34 to an outlet of the relief valve 41. As previously indicated, the relief valve 41 is normally in an closed position such that no circulating cooling fluid is flowing through the tube segment 36 and the relief valve 41.

As noted in regard to FIG. 1, the heat exchanger 2 has a connector 16 at a lower end. The connector 1-6 is interconnected to a bite valve 94 by a tube segment 92. The bite valve 94 is of a type known in the art. The bite valve 94 is normally closed and is opened when a user squeezes the bite valve 94 between their teeth. When the bite valve 94 is opened, the user draws in water as with any drinking straw. The connector 16 in normally open and the heat sink liquid 5 from the reservoir 4 flows freely into tube element 92. The bite valve 94 provides a seal to the reservoir 4 to prevent fluid from escaping through connector 16 and the tube segment 92. The connector 16 is shown to be connected to the reservoir 4 of the exchanger 2. However, alternatively, the connector 16 could connect to a separate reservoir.

In operation, the reservoir 4 is first filled with the heat sink liquid 5. Similarly, the cooling loop 18 is also filled with the circulating cooling fluid. The pump 40 provides hydraulic power to the cooling loop 18. The operation of the heat exchange circuit will be described beginning with the replenishing reservoir 20. The circulating cooling fluid exits the replenishing reservoir 20 through the filter 26 and the tube segment 30. The circulating cooling fluid flows out through the outlet hole 22 and the tube segment 30.

The circulating cooling fluid flowing through the tube segment 30 will enter the pump 40 and be forced forward by the pump 40 through the tube segment 66. The cooling fluid will flow from the tube segment 66 through the T-junction 68 to the tube segment 74. The relief valve 41 is normally in the closed position so that no fluid flows through the tube segments 36 and 62. The circulating cooling fluid will then flow into the inlet connector 12 to the copper tube 10 within the heat exchanger 2. The copper tube 10 is, as noted above, surrounded by heat sink liquid 5, which comprises a mixture of water and ice. The circulating cooling fluid flowing through the copper tube 10 will be cooled by the conduction of heat from the circulating cooling liquid through the copper tube 10 to the heat sink liquid 5 in the reservoir 4 of the heat exchanger 2. The circuitous route of the copper tube 10 through the reservoir 4 is intended to optimize the length of time the circulating cooling fluid, at a given rate, is exposed to the heat sink liquid 5 in the reservoir 4 to facilitate maximum cooling. The circulating cooling fluid flows out through the outlet connector 14 to the tube segment 76.

In operation, the quick disconnect valve 78 is connected to the heat exchange garment 80. The now chilled circulating cooling fluid flows through the outlet 84 and into the heat exchange garment 80 (FIG. 3). The flow of the circulating cooling fluid through the heat exchange garment 80 cools the wearer as described in respect of FIG. 3. The circulating cooling fluid then returns through the return 82 of the quick disconnect valve 78. The circulating cooling fluid returns in a heated state and flows through the tube segment 38, through the T-junction 34, through the tube segment 90 and back through the inlet hole 24 into the replenishing reservoir 20. The cycle is repeated to again cool the circulating cooling fluid and in turn cool the wearer.

The purpose of the relief valve 41 is to protect the pump 40 from damage if the quick disconnect 78 is disconnected from the heat exchange garment 80 while the pump remains running. If this happens, the pressure built by the pump 40 in the circuit will open the relief valve 41 forming an alternative fluid circuit which excludes the heat exchange garment 80 to prevent burn out of the pump 40.

The heat sink liquid 5 contained in the reservoir 4 is gradually warmed and the ice melted by the process of heat exchange with the circulating cooling fluid. As previously noted, the reservoir 4 is connected to the bite valve 94 via the connector 16 and the tube segment 92. When the wearer of the heat exchange system requires hydration, the wearer need only bite on the bite valve and drink the heat sink liquid 5 from the reservoir 4 through the tubing 92. Thus, the reservoir 4 serves a dual purpose. It both functions as the heat sink of the heat exchange system and functions as a fluid reservoir for the hydration of the wearer of the heat exchange garment 80. As an added benefit, the consumption of the fluid portion of the heat sink liquid 5, reduces the thermal load on the heat exchanger 2 since the fluid is the warm component of the ice and fluid mixture which comprises the heat sink liquid 5.

An exemplary heat exchange garment 80 is depicted in FIG. 3. The quick disconnect valve 78 is depicted schematically. As described above, the circulating cooling fluid flows out through the quick disconnect valve 78 and into a network of tubing 100 which extends through a heat exchange garment 80, in this case, a shirt. When the shirt is worn, the flow of the circulating cooling fluid through the shirt provides a second heat exchange system. The circulating cooling fluid is gradually heated, and the wearer cooled, as the heat from the wearer's body is conducted to the circulating cooling fluid. The circulating cooling fluid exits the shirt in a heated condition and returns to the cooling loop 18 depicted in FIG. 2.

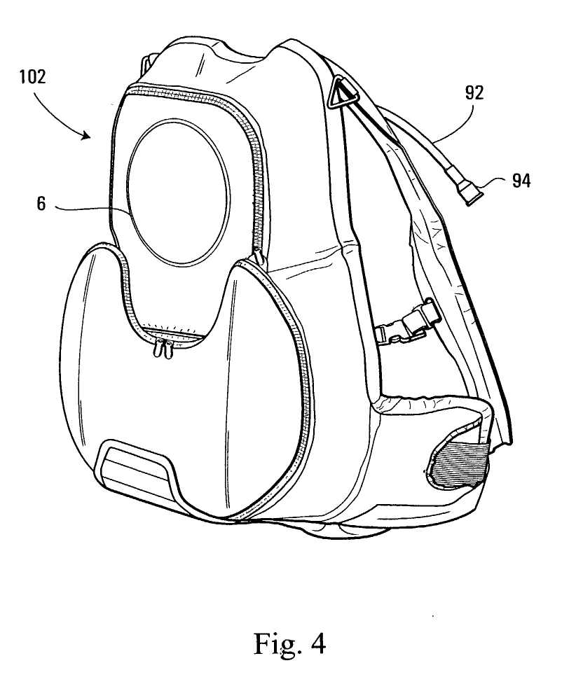

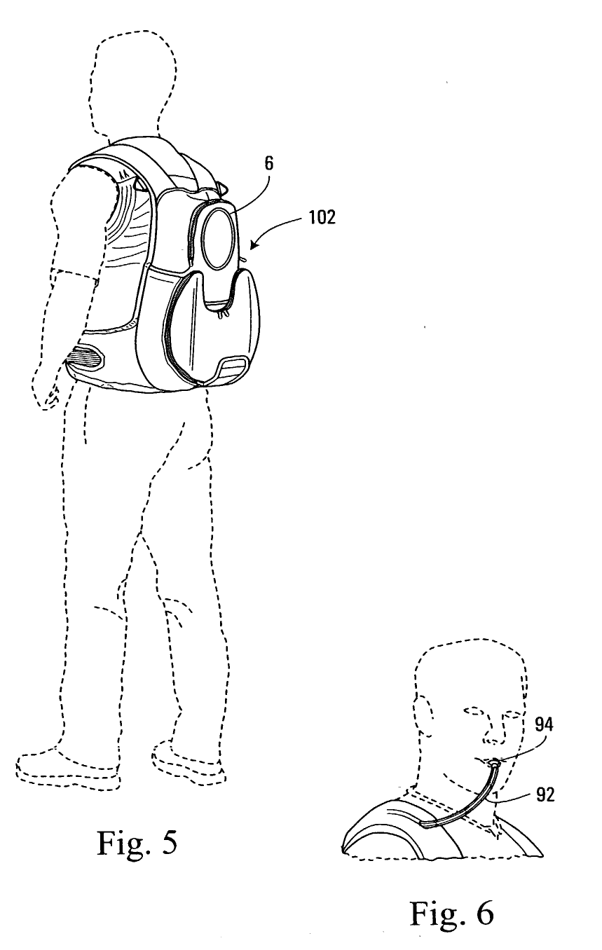

FIG. 4 depicts the preferred physical embodiment of the heat exchange system of the present invention. The entirety of the system including the heat exchanger 2, the pump 40, the replenishing reservoir 20, and all other components of the system are contained within a back pack 102. The backpack 102 can be easily worn by the wearer of the heat exchange garment 80 as shown in FIG. 5. This arrangement makes the system completely portable. When the reservoir 4 has been depleted, the reservoir 4 can easily be refilled by opening the screw cap 6 and filling the reservoir 4. As can be seen in FIG. 4, the tube segment 92 and the bite valve 94 preferably extend at shoulder level from the backpack. The tube segment 92 operates as a straw to allow the wearer to easily drink from the reservoir 4 as shown in FIG. 6. The backpack 102 is preferably constructed of lightweight insulating material to assist in maintaining the reservoir 4 at a low temperature.

The above description of a preferred embodiment should not be interpreted in any limiting manner since variations and refinements can be made without departing from the spirit of the invention. The scope of the invention is defined by the appended claims and their equivalents.

We claim:

1. A portable personal cooling and hydration system comprising:
a heat exchange garment incorporating a garment inlet, a garment outlet and a garment fluid path extending from the garment inlet to the garment outlet;
a heat exchanger having an exchanger inlet, an exchanger outlet and a heat sink wherein the heat exchanger is adapted to receive a supply of fluid through the exchanger inlet and to emit cooled fluid from the exchanger outlet;
a pump;
a plurality of conduits interconnecting the garment fluid path, the heat exchanger and the pump in a circuit, the circuit being adapted to conduct a fluid in operation; and
a reservoir containing a drinkable fluid, associated with the heat exchanger, and incorporating a drinking outlet;
wherein the heat exchanger, the pump, the plurality of conduits and the reservoir are adapted to be carried by a user of the heat exchange garment.

2. A personal cooling and hydration system according to claim 1 wherein the heat exchanger further comprises an exchanger fluid path from the exchanger inlet to the exchanger outlet and wherein the heat sink is external to the exchanger fluid path.

3. A personal cooling and hydration system according to claim 1 wherein the heat sink is the drinkable fluid.

4. A personal cooling and hydration system according to claim 1 wherein the heat exchanger, the pump, the plurality of conduits and the reservoir are adapted to be carried on the body of the user.

5. A personal cooling and hydration system according to claim 4 wherein the heat exchanger, the pump, the plurality of conduits and the reservoir are incorporated into a backpack.

6. A personal cooling and hydration system according to claim 1 further comprising a fluid replenishing reservoir within the circuit.

7. A personal cooling and hydration system according to claim 1 further comprising a quick disconnect between the garment fluid path and the circuit.

8. A personal cooling and hydration system according to claim 1 further comprising a bite valve at a free end of the drinking outlet.

9. A personal cooling and hydration system according to claim 7 further comprising a relief valve in the circuit which bypasses the heat exchange garment.

10. A personal cooling and hydration system according to claim 2 wherein the exchanger fluid path comprises copper tubing which defines a circuitous route through the heat sink.

11. A personal cooling and hydration system according to claim 3 wherein the reservoir further comprises a drain valve at a lower end.

12. A personal cooling and hydration system according to claim 3 wherein the reservoir further comprises an inlet hole at an upper end and a cap adapted to seal the inlet hole.

13. A personal cooling and hydration system according to claim 5 wherein the backpack is insulated.

14. A personal cooling and hydration system according to claim 1 wherein the drinkable fluid is in both a liquid and frozen state.
